(19) United States
(12) Patent Application Publication
(10) Pub. No.: US 2015/0252821 A1
(43) Pub. Date: Sep. 10, 2015

(54) HYDRAULIC ACTUATOR, PRODUCTION METHOD THEREOF, DRIVING METHOD THEREOF, DRIVING DEVICE, AND JOINT STRUCTURE

(71) Applicants: Tomoaki SUGAWARA, Kanagawa (JP); Tsuneaki KONDOH, Kanagawa (JP); Yuko ARIZUMI, Kanagawa (JP); Junichiro NATORI, Kanagawa (JP)

(72) Inventors: Tomoaki SUGAWARA, Kanagawa (JP); Tsuneaki KONDOH, Kanagawa (JP); Yuko ARIZUMI, Kanagawa (JP); Junichiro NATORI, Kanagawa (JP)

(73) Assignee: RICOH COMPANY, LTD., Tokyo (JP)

(21) Appl. No.: 14/616,020

(22) Filed: Feb. 6, 2015

(30) Foreign Application Priority Data
Mar. 6, 2014 (JP) 2014-043398
Dec. 16, 2014 (JP) 2014-253796

(51) Int. Cl. F15B 15/10

(52) U.S. Cl. CPC F15B 15/103; F15B 2215/305

(57) ABSTRACT

A hydraulic actuator, which contains: a tubular elastic body, at least part of which contains short fibers aligned in a longitudinal direction; a fluid storing chamber, which is formed within an internal space of the tubular elastic body, and can store a fluid; and an inlet-outlet pore, which is formed at least one end of the tubular elastic body relative to the longitudinal direction, and can introduce and discharge the fluid into and from the fluid storing chamber.

### BACKGROUND OF THE INVENTION

1. Field of the Invention

The present invention relates to a hydraulic actuator, which is bended or extended by pressure of a fluid, a production method thereof, and a driving method thereof, and a driving device, and a joint structure.

2. Description of the Related Art

As for an actuator of artificial muscles or the like, recently proposed is an embodiment where an elastic body, which is a hollow cylinder, is expanded by introducing a fluid, such as air, into the elastic body, and is contracted in the longitudinal direction thereof. This is classified as McKibben artificial muscle, and has a configuration where a fiber codes netted into a sleeve that restricts an elongation in the longitudinal direction is provided to the outer side of the cylindrical rubber tube, and the actuator is shrunk when a compressed fluid is inserted into the rubber tube.

Moreover, an actuator having a function of bending motions realizes complex movements, and therefore such an actuator is widely applied, and gives high expectation.

For example, proposed is an actuator containing an elastic body composed of a highly rigid part and a low rigid part, in which the actuator is bent towards the side of the highly rigid part, as the low rigid part is expanded by injecting a fluid into a space inside the elastic body (see, for example, Japanese Patent (JP-B) No. 4564788, and Japanese Patent Application Laid-Open (JP-A) No. 05-015485).

For example, proposed id a driving device, in which a plurality of actuators, each being a membrane type actuator loaded in a frame, are connected to realize complex movements (see, for example, JP-B No. 4847096).

However, in these actuators, a rubber tube is merely covered with a fabric code. Therefore, fictions are caused between the rubber tube and the fabric code when it is stretched. As a result, the rubber is torn, and there is a problem that the actuator has low durability.

In order to improve durability of an actuator, provided is an actuator where a ring fiber group and a plurality of fibers are inserted into a cylindrical body to uniformly expand the cylindrical body in the radial direction, in which the ring fiber group contains a plurality of fibers extending in the longitudinal direction of the cylindrical body, which are aligned in the ring form along the circumferential direction of the cylindrical body on the transverse plane of the cylindrical body, and the plurality of the fibers are fibers extending in the longitudinal direction of the cylindrical body and provided at the outer side or inner side of the ratial direction of the ring fiber group (see, for example, JP-B No. 5246717, and JP-A No. 2011-137516).

Moreover, provided is an actuator, where filaments configured to restrict an extension in the longitudinal direction are provided at the outer surface of an elastic tube-shaped body, and cross-sections of the filaments are flattened relative to the periphery of the tube-shaped body (see, for example, JP-A No. 2010-223253).

In these proposed actuators, however, a movement of one actuator is only an extension-contraction movement. In the case where a complex movement is required, it is necessary to mechanically connect a plurality of actuators, and there is a problem that a freedom in designing is low. In these proposed actuators, moreover, a fiber group and filaments tend to be cut due to stress concentration occurred at the interface between the fiber group and the cylindrical body, and the interface between the filaments and the tube-shaped body, and durability thereof is not sufficient.

Accordingly, there is currently a need for a hydraulic actuator, which achieves both high durability, and a high degree of freedom in the design.

### SUMMARY OF THE INVENTION

The present invention aims to solve the aforementioned various problems in the art, and achieve the following object. Specifically, the object of the present invention is to provide a hydraulic actuator, which achieves both high durability and a high degree of freedom in the design thereof.

The means for solving the aforementioned problems are as follows.

The hydraulic actuator of the present invention contains:

a tubular elastic body, at least part of which contains short fibers aligned in a longitudinal direction;

a fluid storing chamber, which is formed within an internal space of the tubular elastic body, and can store a fluid; and

an inlet-outlet pore, which is formed at least one end of the tubular elastic body relative to the longitudinal direction, and can introduce and discharge the fluid into and from the fluid storing chamber.

The present invention can solve the aforementioned various problems in the art, and provide a hydraulic actuator, which achieves both high durability and a high degree of freedom in the design thereof.

### BRIEF DESCRIPTION OF THE DRAWINGS

FIG. 1A is a cross-sectional view illustrating one example of the hydraulic actuator of the present invention.

FIG. 1B is a top view illustrating one example of the hydraulic actuator of the present invention.

FIG. 1C is a cross-sectional view of A-A in FIG. 1B.

FIG. 1D is a top view illustrating one example of the orientation of the short fibers in FIG. 1B.

FIG. 1E is a cross-sectional view illustrating a state when the hydraulic actuator of FIG. 1A is shrunk.

FIG. 2A is a cross-sectional view illustrating another example of the hydraulic actuator of the present invention.

FIG. 2B is a top view illustrating another example of the hydraulic actuator of the present invention.

FIG. 2C is a top view illustrating one example of the orientation of the short fibers in FIG. 2B.

FIG. 2D is a cross-sectional view illustrating a state when the hydraulic actuator of FIG. 2A is shrunk.

FIG. 3A is a cross-sectional view illustrating yet another example of the hydraulic actuator of the present invention.

FIG. 3B is a top view illustrating yet another example of the hydraulic actuator of the present invention.

FIG. 3C is a top view illustrating one example of the orientation of the short fibers of the first elastic sheet.

FIG. 3D is a top view illustrating the second elastic sheet.

FIG. 3E is a cross-sectional view illustrating a state when the hydraulic actuator of FIG. 3A is bent.

FIG. 4A is a cross-sectional view illustrating yet another example of the hydraulic actuator of the present invention.

FIG. 4B is a top view illustrating yet another example of the hydraulic actuator of the present invention.

FIG. 4C is a top view illustrating one example of the orientation of the short fibers in FIG. 4B.

FIG. 4D is a cross-sectional view of A-A′ in FIG. 4A.

FIG. 4E is a cross-sectional view illustrating a state when the hydraulic actuator of FIG. 4A is shrunk.

FIG. 5A is a diagram for explaining one example of the production of a hydraulic actuator of the present invention (part 1).

FIG. 5B is a diagram for explaining one example of the production of a hydraulic actuator of the present invention (part 2).

FIG. 5C is a diagram for explaining one example of the production of a hydraulic actuator of the present invention (part 3).

FIG. 5D is a diagram for explaining one example of the production of a hydraulic actuator of the present invention (part 4).

FIG. 5E is a diagram for explaining one example of the production of a hydraulic actuator of the present invention (part 5).

FIG. 5F is a diagram for explaining one example of the production of a hydraulic actuator of the present invention (part 6).

FIG. 5G is a diagram for explaining one example of the production of a hydraulic actuator of the present invention (part 7).

FIG. 5H is a diagram for explaining one example of the production of a hydraulic actuator of the present invention (part 8).

FIG. 5I is a diagram for explaining one example of the production of a hydraulic actuator of the present invention (part 9).

FIG. 6A is a cross-sectional view illustrating one example of the driving device of the present invention.

FIG. 6B is a top view illustrating one example of the hydraulic actuator in the driving device of FIG. 6A.

FIG. 6C is a top view illustrating one example of the orientation of the short fibers of the first elastic sheet 1.

FIG. 6D is a top view illustrating the second elastic sheet 2A.

FIG. 6E is a cross-sectional view illustrating a state when the hydraulic actuator is bent.

FIG. 7A is a schematic diagram illustrating one example of the joint structure of the present invention.

FIG. 7B is a schematic diagram illustrating one example of the joint structure of the present invention.

FIG. 8 is a graph depicting a relationship between the extension of the hydraulic actuator and the resistance value.

### DETAILED DESCRIPTION OF THE INVENTION

### Hydraulic Actuator

The hydraulic actuator of the present invention contains at least a tubular elastic body, a fluid storing chamber, and an inlet-outlet pore, and may further contain other members, as necessary.

### <Tubular Elastic Body>

The tubular elastic body contains short fibers aligned in the longitudinal direction at least a part thereof.

The tubular elastic body is preferably composed of a first elastic sheet and a second elastic sheet.

### <<First Elastic Sheet and Second Elastic Sheet>>

The first elastic sheet, or the second elastic sheet, or both contain short fibers aligned in the longitudinal direction.

The second elastic sheet is overlapped with the first elastic sheet, and a peripheral part of the second elastic sheet is bonded to a peripheral part of the first elastic sheet.

In the present specification, the short fibers aligned in the longitudinal direction means a state where the degree of the orientation of the short fibers to the longitudinal direction is 50% or greater. The degree of the orientation means a ratio (%) of the short fibers aligning with an angle within ±30° from the longitudinal direction, when a surface of the tubular elastic body (e.g., the first elastic sheet or second elastic sheet containing the short fibers), and is an average value when arbitrarily selected 12 points on a surface of the tubular elastic body (e.g., the first elastic sheet or second elastic sheet containing the short fibers) are measured. The degree of the orientation can be confirmed, for example, by observing a surface of the tubular elastic body (e.g., the first elastic sheet or second elastic sheet containing the short fibers) under a microscope (e.g., KEYENCE Microscope: VHX-1000, zoom lens: VH-Z100R, manufactured by KEYENCE CORPORATION) at a magnification (a field of view: 800 μm×600 μm) of 300×. The phrase “angle within ±30°” means an angle that is within ±30° from the longitudinal direction in a field of view, when a surface of the tubular elastic body (e.g., the first elastic sheet or second elastic sheet containing the short fibers) is observed. Note that, as for the observation, only short fibers having a length of 30 μm or greater are treated as observation targets, and the fibers having a length of less than 30 μm are excluded from the observation targets. This is because the fibers having a length of less than 30 μm less contribute to extension-contraction, or bending of the hydraulic actuator.

The degree of the orientation is appropriately selected depending on the intended purpose without any limitation, provided that it is 50% or greater. The degree of the orientation is preferably 70% or greater, more preferably 80% or greater. When the degree of the orientation is 70% or greater, it is advantageous in view of durability.

The tubular elastic body is appropriately selected depending on the intended purpose without any limitation, provided that it is in the shape of a tube, and has elasticity. The tubular elastic body preferably at least rubber, and optionally other components, as necessary.

The first elastic sheet is appropriately selected depending on the intended purpose without any limitation, provided that it is a sheet having elasticity. The first elastic sheet contains at least rubber, preferably further contains short fibers aligned in the longitudinal direction, and preferably further contains other components as necessary.

The second elastic sheet is appropriately selected depending on is the intended purpose without any limitation, provided that it is a sheet having elasticity. The second elastic sheet contains at least rubber, preferably further contains short fibers aligned in the longitudinal direction, and preferably further contains other components as necessary.

The tubular elastic body preferably has electrical conductivity. Since the tubular elastic body has electrical conductivity, the hydraulic actuator can be driven easily with high accuracy by the below-mentioned driving method of the hydraulic actuator, and driving device.

The elastic sheet, which is the first elastic sheet, or the second elastic sheet, or both, and contains the short fibers, preferably has electrical conductivity. As a result of this, the hydraulic actuator can be driven easily with high accuracy by the below-mentioned driving method of the hydraulic actuator, and driving device.

The electrical conductivity can be applied to the elastic sheet, for example by using carbon fibers as the short fibers.

In the present specification, the tubular elastic body or elastic sheet having electrical conductivity is appropriately selected depending on the intended purpose without any limitation, provided that it is a level of the electrical conductivity with which the electric resistance value can be measured. For example, the electric resistance value when the hydraulic actuator is not driven is 1×10¹Ω to 1×10⁸Ω.

### <<Short Fibers>>

The short fibers are appropriately selected depending on the intended purpose without any limitation, and examples thereof include carbon fibers, and glass fibers.

Examples of the carbon fibers include pitch-based carbon fibers, formed from coal tar or petroleum pitch, and PAN (polyacrylonitrile)-based carbon fibers formed from acryl long fiber of synthetic fiber.

The pitch based carbon fibers are obtained by carbonizing a pitch precursor (pitch fibers obtained from a raw material that is coal tar or heavy petroleum fraction), and the pitch-based carbon fibers of wide-raged characteristics from low elasticity to ultrahigh elasticity and high strength can be obtained by a production method of various conditions. Examples of a commercial product of the pitch-based carbon fibers include GRANOC® XN-100-05M (manufactured by Nippon Graphite Fiber Co., Ltd.).

The PAN-based carbon fibers are obtained by carbonizing a PAN precursor (polyacrylonitrile fibers), and have properties of high strength and high elasticity. Examples of a commercial product of the PAN-based carbon fibers include: TORAYCA® Milled Fiber MLD-30, MLD-300, MLD-1000 (all manufactured by TORAY INDUSTRIES, INC.); and PYROFIL Chopped Fiber (manufactured by MITSUBISHI RAYON CO., LTD.).

The carbon fibers have weak adhesion to rubber (e.g., silicone rubber), but the adhesion thereof can be sufficiently improved by performing an appropriate primer processing, or surface oxidization processing. As a result, the hydraulic actuator having even better durability can be attained.

The glass fibers are preferable, as they have excellent adhesion particularly to the silicone rubber. Examples of a commercial product of the glass fibers include Milled Fiber EFH30-31, EFH50-31, EFH75-01, EFH100-31, EFH150-01 (all manufactured by Central Glass Co., Ltd.).

In the present specification, the short fibers mean fibers having the average fiber length of 30 μm to 500 μm. The average fiber length of the short fibers is preferably 30 μm to 150 μm, more preferably 50 μm to 150 μm.

The average fiber length is the number average fiber length, and can be determined, for example, by the following method. One or two drops of a liquid containing the short fibers are placed on a glass plate using a dropper. The lengths of the short fibers are measured using a microscopic or laser microscopic image. As for the measurement of the length, an image processing device, such as LUZEX AP, manufactured by NIRECO CORPORATION, can be also used. The lengths of the 500 short fibers observed in the microscopic image are measured. And the number average fiber length, which is the arithmetic mean value, is determined.

An aspect ratio (the average fiber length/the average diameter) of the short fibers is appropriately selected depending on the intended purpose without any limitation, but the aspect ratio thereof is preferably 2.0 or greater, more preferably 4.0 or greater, and even more preferably 5.0 or greater. The upper limit of the aspect ratio is appropriately selected depending on the intended purpose without any limitation, but the aspect ratio is preferably 30 or less.

An amount of the short fibers in the tubular elastic body is appropriately selected depending on the intended purpose without any limitation, but the amount thereof is preferably 10 parts by weight to 60 parts by weight, more preferably 20 parts by weight to 50 parts by weight, and even more preferably 35 parts by weight to 50 parts by weight, relative to 100 parts by weight of the rubber. When the amount thereof is in the aforementioned even more preferable range, it is preferable in terms of durability.

An amount of the short fibers in the first elastic sheet is appropriately selected depending on the intended purpose without any limitation, but the amount thereof is preferably 10 parts by weight to 60 parts by weight, more preferably 20 parts by weight to 50 parts by weight, and even more preferably 35 parts by weight to 50 parts by weight, relative to 100 parts by weight of the rubber. When the amount thereof is in the aforementioned even more preferable range, it is preferable in terms of durability.

An amount of the short fibers in the second elastic sheet is appropriately selected depending on the intended purpose without any limitation, but the amount thereof is preferably 10 parts by weight to 60 parts by weight, more preferably 20 parts by weight to 50 parts by weight, and even more preferably 35 parts by weight to 50 parts by weight, relative to 100 parts by weight of the rubber. When the amount thereof is in the aforementioned even more preferable range, it is preferable in terms of durability.

### <<Rubber>>

The rubber is appropriately selected depending on the intended purpose without any limitation, and examples thereof include natural rubber, SBR, butyl rubber, chloroprene rubber, nitrile rubber, acrylic rubber, urethane rubber, silicone rubber, fluorosilicone rubber, fluorine rubber, and liquid fluorinated elastomer. Among them, silicone rubber is preferable, as the silicone rubber has excellent biocompatibility, and does not tend to cause allergy. Moreover, RTV (room temperature vulcanization) silicone rubber is also preferable, as carbon fibers can be easily dispersed therein. Moreover, natural rubber whose protein content is reduced is also preferable, considering a contact with skin.

The silicone rubber is appropriately selected depending on the intended purpose without any limitation, provided that it is rubber having an organosiloxane structure. The silicone rubber may be selected from commercial products. Examples of the commercial products thereof include KE-1950-30 (manufactured by Shin-Etsu Chemical Co., Ltd.), and DY35-2083 (manufactured by Dow Corning Toray Co., Ltd.). Among the aforementioned silicone rubber, addition-type liquid silicone rubber is preferable, as it is cured at the temperature in the approximate range of 90° C. to 140° C., and has excellent processability.

The tubular elastic body preferably has an inflation controlling unit formed by bonding part of the inner plane with facing part of the other inner plane in the fluid storing chamber. As the hydraulic actuator contains the inflation controlling unit, the inflated volume in the thickness direction of the hydraulic actuator can be controlled.

The first elastic sheet and the second elastic sheet preferably forms an inflation controlling unit with bonding part of an inner surface of the fluid storing chamber to part of the facing surface. As the hydraulic actuator contains the inflation controlling unit, the inflated volume in the thickness direction of the hydraulic actuator can be controlled.

The average thickness of the tubular elastic body is appropriately selected depending on the intended purpose without any limitation, but the average thickness thereof is preferably 100 μm to 1 mm, more preferably 150 μm to 500 μm and even more preferably 200 μm to 300 μm. When the average thickness thereof is in the aforementioned even more preferable range, it is preferable in terms of durability

In the present specification, the thickness of the tubular elastic body means a distance between the outermost surface and the innermost surface of the tubular elastic body.

The average thickness of the first elastic sheet is appropriately selected depending on the intended purpose without any limitation, but the average thickness thereof is preferably 100 μm to 1 mm, more preferably 150 μm to 500 μm, and even more preferably 200 μm to 300 μm. When the average thickness of the first elastic sheet is within the aforementioned even more preferable range, it is advantageous in terms of durability.

The average thickness of the second elastic sheet is appropriately selected depending on the intended purpose without any limitation, but the average thickness thereof is preferably 100 μm to 1 mm, more preferably 150 μm to 500 μm, and even more preferably 200 μm to 300 μm. When the average thickness of the second elastic sheet is within the aforementioned even more preferable range, it is advantageous in terms of durability.

A method for bonding the peripheral part of the first elastic sheet and the peripheral part of the second elastic sheet is appropriately selected depending on the intended purpose without any limitation, and examples thereof include; a method where the peripheral part of the first elastic sheet and the peripheral part of the second elastic sheet are bonded with an adhesive; and a method where the peripheral part of the first elastic sheet and the peripheral part of the second elastic sheet, which are both in a semi-cured state before being cured, are overlapped, and are bonded in the process of the curing.

### <Fluid Storing Chamber>

The fluid storing chamber can store a fluid.

The fluid storing chamber is formed within an inner space of the tubular elastic body.

The fluid storing chamber is formed, for example, between the first elastic sheet and the second elastic sheet.

A capacity and shape of the fluid storing chamber are appropriately selected depending on the intended purpose without any limitation.

The fluid stored in the fluid storing chamber is appropriately selected depending on the intended purpose without any limitation, and examples thereof include air, nitrogen, and water.

The pressure of the fluid stored in the fluid storing chamber is appropriately selected depending on the intended purpose without any limitation.

### <Inlet-Outlet Pore>

The inlet-outlet pore is appropriately selected depending on the intended purpose without any limitation, provided that it is formed at least one end of the tubular elastic body relative to the longitudinal direction thereof, and can introduce and discharge the fluid into and from the fluid storing chamber.

For example, the inlet-outlet pore is formed at least one end relative to the longitudinal direction of the first elastic sheet and the second elastic sheet.

A size and shape of the inlet-outlet pore are appropriately selected depending on the intended purpose without any limitation.

One example of the hydraulic actuator of the present invention is explained with reference to drawings, hereinafter.

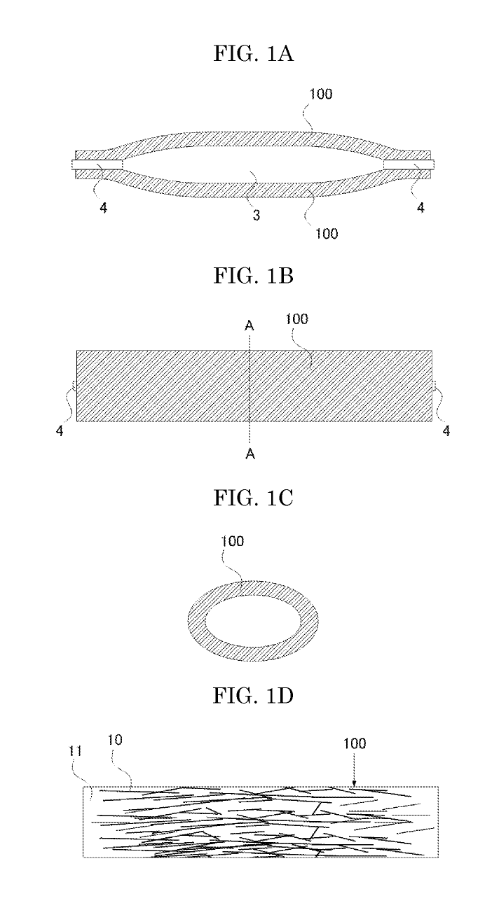

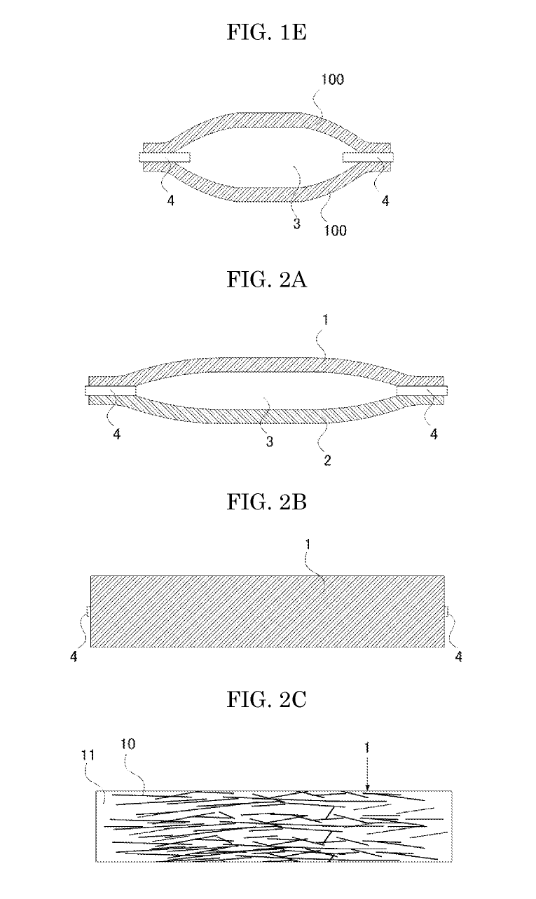

FIGS. 1A to 1E are schematic diagrams illustrating one example of the hydraulic actuator of the present invention.

FIG. 1A is a cross-sectional view illustrating one example of the hydraulic actuator of the present invention.

FIG. 1B is a top view illustrating one example of the hydraulic actuator of the present invention.

FIG. 1C is a cross-sectional view of A-A in FIG. 1B.

FIG. 1D is a top view illustrating one example of the orientation of the short fibers in FIG. 1B.

FIG. 1E is a cross-sectional view illustrating a state when the hydraulic actuator of FIG. 1A is shrunk.

The hydraulic actuator of FIGS. 1A to 1E contains a tubular elastic body 100, a fluid storing chamber 3, and inlet-outlet pores each formed with a pipe 4. In the internal space of the tubular elastic body 100, the fluid storing chamber 3 capable of storing a fluid is formed. Moreover, the inlet-outlet pores each capable of introducing and discharging a fluid into and from the fluid storing chamber 3 are formed with the pipes 4 at both ends of the tubular elastic body 100 relative to the longitudinal direction thereof.

As illustrated in FIG. 1D, the tubular elastic body 100 contains short fibers 10, and silicone rubber 11. In the tubular elastic body 100, the short fibers 10 are aligned in the longitudinal direction of the tubular elastic body 100.

With this hydraulic actuator, as a fluid is stored in the fluid storing chamber 3, the tubular elastic body 100 tries to expand with the pressure caused by the fluid. Since the tubular elastic body 100 contains the short fibers aligned in the longitudinal direction, the extension along the longitudinal direction is restricted. On the other hand, the extension along the short direction is hardly restricted. As a result, the length thereof along the longitudinal direction is shortened (shrunk), as illustrated in FIG. 1E. Moreover, the hydraulic actuator of FIGS. 1A to 1E contains the short fibers 10, which are the member for regulating expansion, within the tubular elastic body 100. Therefore, less friction is cause between the silicone rubber that is a base material of the tubular elastic body 100 and the short fibers, when the hydraulic actuator is expanded and contracted, and thus the hydraulic actuator excels in the durability. Since the fibers that are a member for regulating the expansion are short fibers, moreover, the stress concentration is hardly caused. The hydraulic actuator excels in the durability thereof also in view of this point.

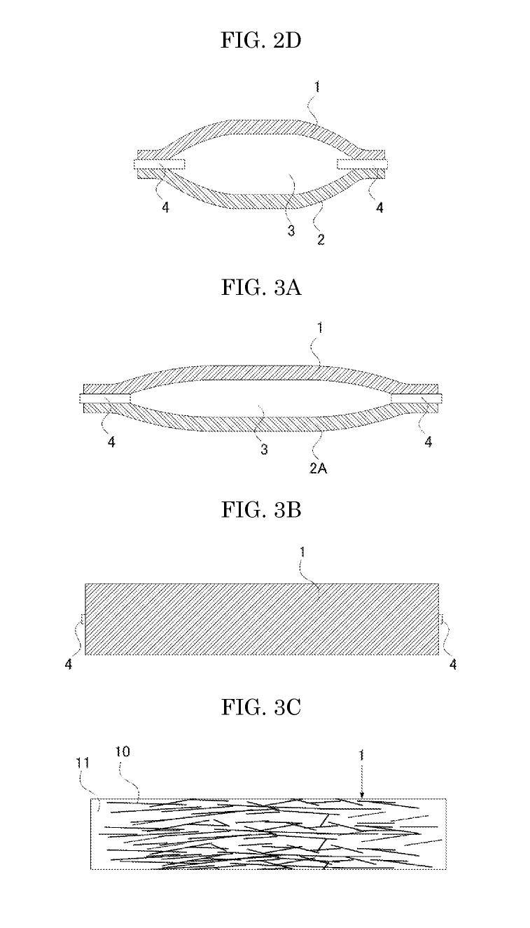

FIGS. 2A to 2D are schematic diagram illustrating another example of the hydraulic actuator of the present invention.

FIG. 2A is a cross-sectional view illustrating another example of the hydraulic actuator of the present invention.

FIG. 2B is a top view illustrating another example of the hydraulic actuator of the present invention.

FIG. 2C is a top view illustrating one example of the orientation of the short fibers in FIG. 2B.

FIG. 2D is a cross-sectional view illustrating a state when the hydraulic actuator of FIG. 2A is shrunk.

The hydraulic actuator of FIGS. 2A to 2D contains a first elastic sheet 1, a second elastic sheet 2, a fluid storing chamber 3, and inlet-outlet pores each formed with a pipe 4. The first elastic sheet 1 and the second elastic sheet 2 are bonded together with the peripheral part of the first elastic sheet 1 overlapping with the peripheral part of the second elastic sheet 2. The first elastic sheet 1 and the second elastic sheet 2 are not bonded other than the peripheral part of the first elastic sheet 1 and the peripheral part of the second elastic sheet 2, and thus a fluid storing chamber 3 capable of storing a fluid is formed between the first elastic sheet 1 and the second elastic sheet 2. Moreover, the inlet-outlet pores each capable of introducing and discharging a fluid into and from the fluid storing chamber 3 are formed with the pipes 4 at both ends of the first elastic sheet 1 and the second elastic sheet 2 relative to the longitudinal direction thereof.

As illustrating in FIG. 2C, the first elastic sheet 1 contains short fibers 10, and silicone rubber 11. In the first elastic sheet 1, the short fibers 10 are aligned in the longitudinal direction of the first elastic sheet 1. Although it is not illustrated in the drawing, the second elastic sheet 2 has the same structure.

With this hydraulic actuator, as a fluid is stored in the fluid storing chamber 3, the first elastic sheet 1 and the second elastic sheet 2 try to expand with the pressure caused by the fluid. As the first elastic sheet 1 and the second elastic sheet 2 contain the short fibers aligned in the longitudinal direction, the extension along the longitudinal direction is restricted. On the other hand, the extension along the short direction is hardly restricted. As a result, the length thereof along the longitudinal direction is shortened (shrunk), as illustrated in FIG. 2D. Moreover, the hydraulic actuator of FIGS. 2A to 2D contains the short fibers 10, which are the member for regulating expansion, within the first elastic sheet 1 and the second elastic sheet 2. Therefore, less friction is cause between the silicone rubber that is a base material of the first elastic sheet 1 and the second elastic sheet 2, and the short fibers, when the hydraulic actuator is expanded and contracted, and thus the hydraulic actuator excels in the durability. Since the fibers that are a member for regulating the expansion are short fibers, moreover, the stress concentration is hardly caused. The hydraulic actuator excels in the durability thereof also in view of this point.

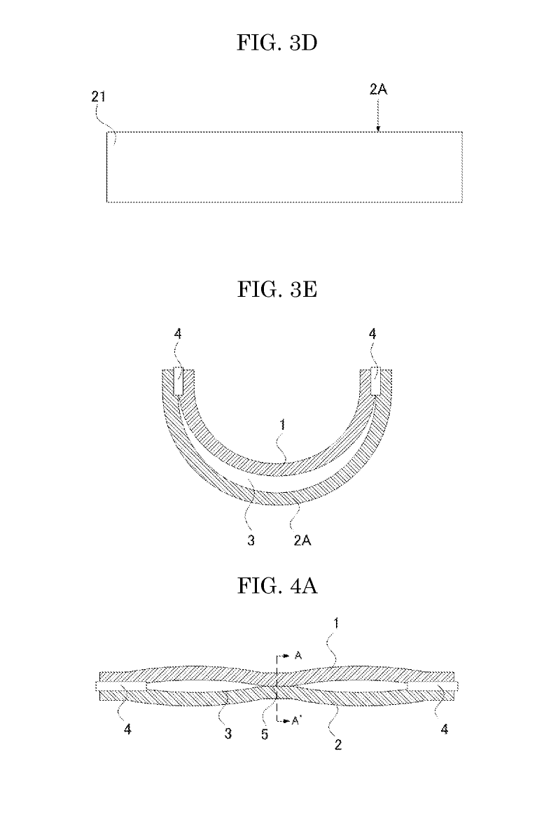

FIGS. 3A to 3E are schematic diagrams illustrating yet another example of the hydraulic actuator of the present invention. This hydraulic actuator is a type of a hydraulic actuator, which is bent.

FIG. 3A is a cross-sectional view illustrating yet another example of the hydraulic actuator.

FIG. 3B is a top view illustrating yet another example of the hydraulic actuator of the present invention.

FIG. 3C is a top view illustrating one example of the orientation of the short fibers of the first elastic sheet 1.

FIG. 3D is a top view illustrating the second elastic sheet 2A.

FIG. 3E is a cross-sectional view illustrating a state when the hydraulic actuator of FIG. 3A is bent.

The hydraulic actuator of FIGS. 3A to 3E contains a first elastic sheet 1, a second elastic sheet 2A, a fluid storing chamber 3, and inlet-outlet pores each formed with a pipe 4. The first elastic sheet 1 and the second elastic sheet 2A are bonded with the peripheral part of the first elastic sheet 1 overlapping with the peripheral part of the second elastic sheet 2A. Since the first elastic sheet and the second elastic sheet 2A are not bonded other than the peripheral part of the first elastic sheet 1 and the peripheral part of the second elastic sheet 2A, a fluid storing chamber 3 capable of storing a fluid is formed between the first elastic sheet 1 and the second elastic sheet 2A. Moreover, the inlet-outlet pores each capable of introducing and discharging a fluid into and from the fluid storing chamber 3 are formed with the pipes 4 at both ends of the first elastic sheet 1 and the second elastic sheet 2A relative to the longitudinal direction thereof.

As illustrated in FIG. 3C, the first elastic sheet 1 contains short fibers 10, and silicone rubber 11. In the first elastic sheet 1, the short fibers 10 are aligned in the longitudinal direction of the first elastic sheet 1.

As illustrated in FIG. 3D, the second elastic sheet 2A contains silicone rubber 21, but dies not contain short fibers.

With the hydraulic actuator of FIGS. 3A to 3E, as a fluid is stored in the fluid storing chamber 3, the first elastic sheet 1 and the second elastic sheet 2A try to expand with the pressure caused by the fluid. Since the first elastic sheet 1 contains the short fibers aligned in the longitudinal direction, the extension along the longitudinal direction is restricted, but the extension in the short direction is hardly restricted. On the other hand, the second elastic sheet 2A does not contain the short fibers, and thus there is no restriction applied on the extension as in the first elastic sheet 1. As a result, the hydraulic actuator bends in the direction of the first elastic sheet 1, as illustrated in FIG. 3E. Moreover, the hydraulic actuator of FIGS. 3A to 3E contains the short fibers 10, which are the member for regulating expansion, within the first elastic sheet 1. Therefore, less friction is caused between the silicone rubber that is a base material of the first elastic sheet 1 and the short fibers when the hydraulic actuator is expanded and contracted, and thus the hydraulic actuator excels in the durability. Since the fibers that are a member for regulating the expansion are short fibers, moreover, the stress concentration is hardly caused. The hydraulic actuator excels in the durability thereof also in view of this point.

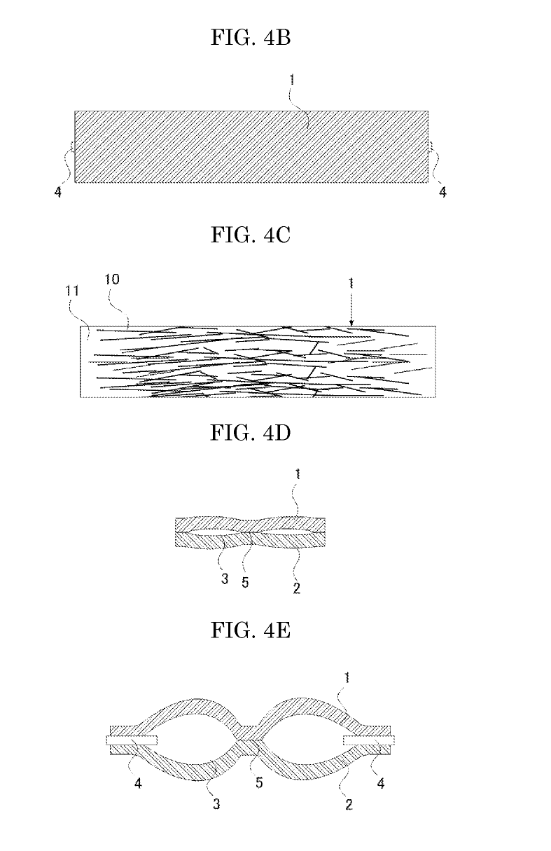

FIGS. 4A to 4E are schematic diagrams illustrating yet another example of the hydraulic actuator of the present invention. This hydraulic actuator is a type of a hydraulic actuator which has an inflation controlling unit.

FIG. 4A is a cross-sectional view illustrating yet another example of the hydraulic actuator of the present invention.

FIG. 4B is a top view illustrating yet another example of the hydraulic actuator of the present invention.

FIG. 4C is a top view illustrating one example of the orientation of the short fibers in FIG. 4B.

FIG. 4D is a cross-sectional view of A-A′ in FIG. 4A.

FIG. 4E is a cross-sectional view illustrating a state when the hydraulic actuator of FIG. 4A is shrunk.

The hydraulic actuator of FIGS. 4A to 4E contains a first elastic sheet 1, a second elastic sheet 2, a fluid storing chamber 3, inlet-outlet pores each formed with a pipe 4, and an inflation controlling member 5. The first elastic sheet 1 and the second elastic sheet 2 are bonded with the peripheral part of the first elastic sheet 1 overlapping with the peripheral part of the second elastic sheet 2. A fluid storing chamber 3 capable of storing a fluid is formed between the first elastic sheet 1 and the second elastic sheet 2. At the center part of the fluid storing chamber 3, part of the first elastic sheet 1 and part of the second elastic sheet 2 are bonded to form the inflation controlling unit 5. Moreover, the inlet-outlet pores each capable of introducing and discharging a fluid into and from the fluid storing chamber 3 are formed with the pipes 4 at both ends of the first elastic sheet 1 and the second elastic sheet 2 relative to the longitudinal direction thereof.

As illustrated in FIG. 4C, the first elastic sheet 1 contains short fibers 10, and silicone rubber 11. In the first elastic sheet 1, the short fibers 10 are aligned in the longitudinal direction of the first elastic sheet 1. Although it is not illustrated in the diagram, the second elastic sheet 2 has the same structure.

As illustrated in FIG. 4D, moreover, the fluid storing chamber 3 in the cross-sectional view of FIG. 4A is not separated into two chambers with the inflation controlling unit 5.

With this hydraulic actuator, as a fluid is stored in the fluid storing chamber 3, the first elastic sheet 1 and the second elastic sheet 2 try to expand with the pressure caused by the fluid. Since the first elastic sheet 1 and the second elastic sheet 2 contain the short fibers aligned in the longitudinal direction, however, the extension along the longitudinal direction is restricted. On the other hand, the extension along the short direction is hardly restricted. Moreover, the expansion of the hydraulic actuator in the thickness direction is controlled by the inflation controlling unit 5. As a result, the length thereof in the longitudinal direction becomes short (shrinks), as illustrated in FIG. 4E. Moreover, the hydraulic actuator of FIGS. 4A to 4E contains the short fibers 10, which are the member for regulation expansion, within the first elastic sheet 1 and the second elastic sheet 2. Therefore, less friction is caused between the silicone rubber, which is a base material of the first elastic sheet 1 and the second elastic sheet 2, and the short fibers, when the hydraulic actuator is expanded and contracted, and the hydraulic actuator excels in the durability. Since the fibers that are a member for regulating the expansion are short fibers, moreover, the stress concentration is hardly caused. The hydraulic actuator excels in the durability thereof also in view of this point.

A production method of the hydraulic actuator of the present invention is appropriately selected depending on the intended purpose without any limitation, but the following production method is preferable, because the orientation of the short fibers is easily controlled.

### (Production Method of Hydraulic Actuator)

The production method of a hydraulic actuator according to the present invention contains at least a coating step, and may further contain other steps, as necessary.

### <Coating Step>

The coating step is appropriately selected depending on the intended purpose without any limitation, provided that it contains applying a coating liquid containing short fibers and rubber on a coating surface using a coating unit, with relatively moving the coating surface and the coating unit.

The coating unit is appropriately selected depending on the intended purpose without any limitation, provided that it is a unit configured to apply the coating liquid on the coating surface by passing the coating liquid through a space between the coating surface and the coating unit.

As the relative movement between the coating surface and the coating unit in the coating step is the longitudinal direction of the tubular elastic body to be obtained (e.g., the first elastic sheet or second elastic sheet containing the short fibers), the short fibers can be aligned in the longitudinal direction of the tubular elastic body (e.g., the first elastic sheet or second elastic sheet containing the short fibers).

In the coating step, a thickness of the tubular elastic body to be obtained (e.g., the first elastic sheet or second elastic sheet containing the short fibers) and the orientation of the short fibers in the tubular elastic body (e.g., the first elastic sheet or second elastic sheet containing the short fibers) can be controlled by the speed of the relative movement between the coating unit and the coating surface, the viscosity of the coating liquid, the solid content of the coating liquid, and the distance of the space between the coating surface and the coating unit.

Examples of the coating unit of a laboratory scale include a gap applicator. Examples of the gap applicator include a baker film applicator, and a bird film applicator. Examples of a commercial product of the gap applicator include K Paint Applicator (manufactured by Matsuo Sangyo Co., Ltd.), Baker-type Film Applicator (manufactured by Yasuda Seiki Seisakusho LTD.), and Bird Film Applicator (manufactured by COTEC Corporation).

Examples of the coating unit of an industrial scale include a die coater, a lip coater, and a dam coater.

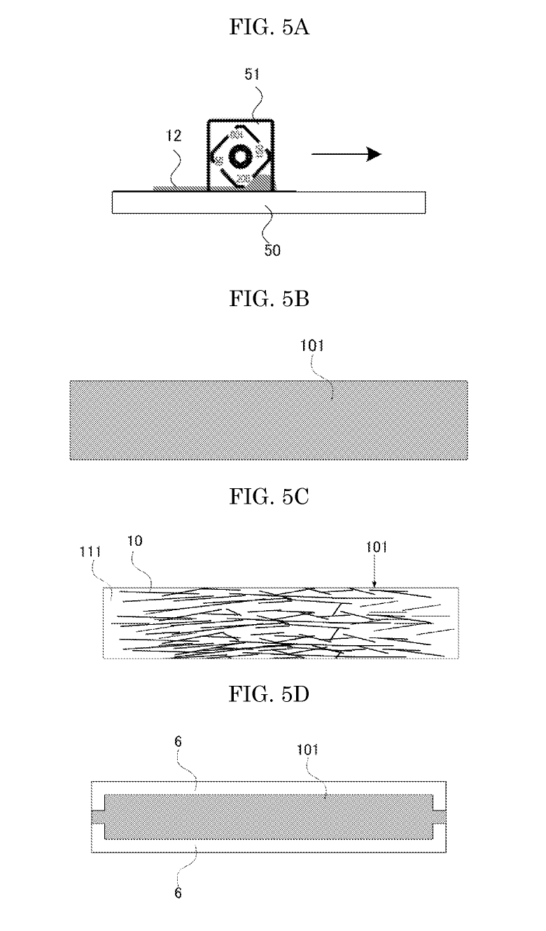

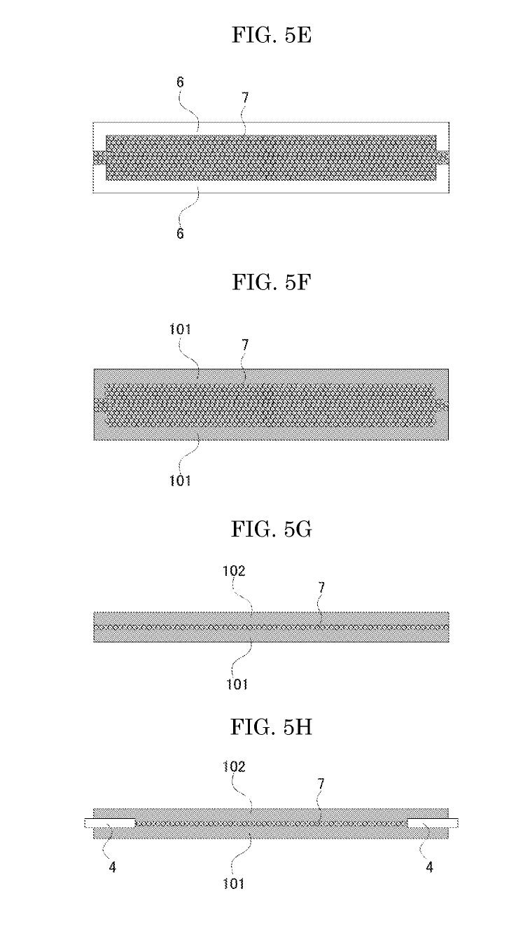

One example of the production method of a hydraulic actuator of the present invention is explained with reference to FIGS. 5A to 5I, hereinafter.

First, as illustrated in FIG. 5A, a coating liquid 12 containing short fibers and silicone rubber is applied onto a support 50 formed of stainless steel by means of a bird film applicator 51. During this operation, the bird film applicator 51 is moved in the direction depicted with an arrow in FIG. 5A. Note that, the direction of the arrow is a longitudinal direction of a resulting first elastic sheet.

Thereafter, the resultant is heated at temperature at which the silicone rubber is not completely cured, to thereby obtain a first elastic sheet precursor 101 of FIGS. 5B and 5C.

As illustrated in FIG. 5C, the first elastic sheet precursor 101 contains short fibers 10, and silicone rubber 111 before being completely cured. In the first elastic sheet precursor 101, the short fibers 10 are aligned in the longitudinal direction of the first elastic sheet precursor 101.

Subsequently, as illustrated in FIG. 5D, a mask sheet 6 is placed on a surface of the first elastic sheet precursor 101, which is to be a contact surface with the second elastic sheet.

Subsequently, hollow filler 7, which is melted upon application of heat, is blown onto the area of the surface of the first elastic sheet precursor 101, which is not covered with the mask sheet 6 (FIG. 5F). The hollow filler 7 is a group of balloons each formed of a film of nano order, and the balloons are shrunk at secondary baking temperature at which the silicone rubber is completely cured. This is used as a separating agent working between the first elastic sheet and the second elastic sheet.

Subsequently, as illustrated in FIG. 5G, the coating liquid 12 is applied on the surface of the first elastic sheet precursor 101, on which the hollow filler 7 had been fixed, by means of the bird film applicator 51 along the longitudinal direction of the first elastic sheet precursor 101. Thereafter, the resultant is heated to temperature at which the silicone rubber is not completely cured to laminate a second elastic sheet precursor 102 on the first elastic sheet precursor 101, to thereby obtain a laminate.

Subsequently, the substrate (not illustrated) is removed. Thereafter, stainless steel pipes 4, to which an adhesive silicone rubber has been deposited, are inserted at the positions that are respectively centers of both edges of the first elastic sheet precursor 101 and the second elastic sheet precursor 102 relative to the longitudinal direction, and at the interface between the first elastic sheet precursor 101 and the second elastic sheet precursor 102, in a manner that each pipe reaches to the surface to which the hollow filler 7 has been fixed, as illustrated in FIG. 5H.

Subsequently, the laminate, to which the stainless steel pipes 4 have been inserted, is placed on a fluororesin sheet (not illustrate), and the laminate is heated at temperature at which the silicone rubber is completely cured. This heating completely cures the silicone rubbers of the first elastic sheet precursor 101 and the second elastic sheet precursor 102, and pops the hollow filler 7, to thereby form the first elastic sheet 1 and the second elastic sheet 2, as well as forming a fluid storing chamber 3, which is a space capable of storing a fluid, between the first elastic sheet 1 and the second elastic sheet 2.

In the manner as described above, the hydraulic actuator is obtained.

### (Driving Method of Hydraulic Actuator)

The driving method of a hydraulic actuator according to the present invention contains at least an electric resistance value measuring step, and a controlling step, and may further contain other steps, as necessary.

The hydraulic actuator operated by pressure of a fluid (e.g. air), such as a McKibben actuator, has poor response due to an influence from elastic characteristics due to compressive properties of the fluid, or flow channel resistance. Therefore, there has been a problem that it is difficult to control the hydraulic actuator, such as the desired precise control cannot be realized with a typical feedback control, which has been conventionally used.

Considering the problem above, proposed is a method where the internal state (e.g. pressure) of the actuator is measured, and control is performed based on the measurement, as disclosed in JP-B No. 4563512. The intended use of this method is for a domestic robot, and this method realizes high speed operation

However, the proposed method requires extremely complicated calculations. Moreover, the proposed method requires an encoder and a pressure sensor for measuring the internal pressure, and thus the structure of the device becomes extremely complicated.

On the other hand, the driving method of a hydraulic actuator of the present invention achieves precise operation using a relatively simple structure.

Moreover, the below-mentioned driving device of the present invention also achieves precise operation with a relatively simple structure.

### <Electric Resistance Value Measuring Step>

The electric resistance value measuring step is appropriately selected depending on the intended purpose without any limitation, provided that it contains measuring an electric resistance value of the tubular elastic body of the hydraulic actuator of the present invention. Examples thereof include a method containing attaching electrodes to the tubular elastic body (e.g., the first elastic sheet or second elastic sheet), and measuring an electric resistance value of the tubular elastic body (e.g., the first elastic sheet or second elastic sheet) by an electric resistance value measuring unit through the electrodes.

### <Controlling Step>

The controlling step is appropriately selected depending on the intended purpose without any limitation, provided that it contains controlling an amount of a fluid to be introduced into the hydraulic actuator based on the measured electric resistance value. In the case where the fluid is air, examples of the controlling step include a method, which uses an air tank and a valve, and contains adjusting the opening degree of the valve based on the measured electric resistance value, to thereby control an amount of the air introduced from the air tank to the hydraulic actuator.

### (Driving Device)

The driving device of the present invention contains at least the hydraulic actuator of the present invention, an electric resistance value measuring unit, and a controlling unit, and may further contain other units, as necessary.

### <Electric Resistance Value Measuring Unit>

The electric resistance value measuring unit is appropriately selected depending on the intended purpose without any limitation, provided that it is connected to the tubular elastic body (e.g., the first elastic sheet, and the second elastic sheet) of the hydraulic actuator, to measure an electric resistance value of the tubular elastic body (e.g., the first elastic sheet, and the second elastic sheet). Examples of the electric resistance value measuring unit include an ohmmeter.

### <Controlling Unit>

The controlling unit is appropriately selected depending on the intended purpose without any limitation, provided that it is a unit configured to control an amount of a fluid introduced into the hydraulic actuator based on the measured electric resistance value. In the case where the fluid is air, examples of the control unit include a combination of an air tank and a valve.

### (Joint Structure)

The joint structure of the present invention contains the hydraulic actuator of the present invention, and a joint movable by the hydraulic actuator, and may further contain other members, as necessary.

The joint structure of the present invention realizes precise motions with a relatively simple structure.

One example of the driving device of the present invention and the driving method of a hydraulic actuator of the present invention is explained with reference to drawings.

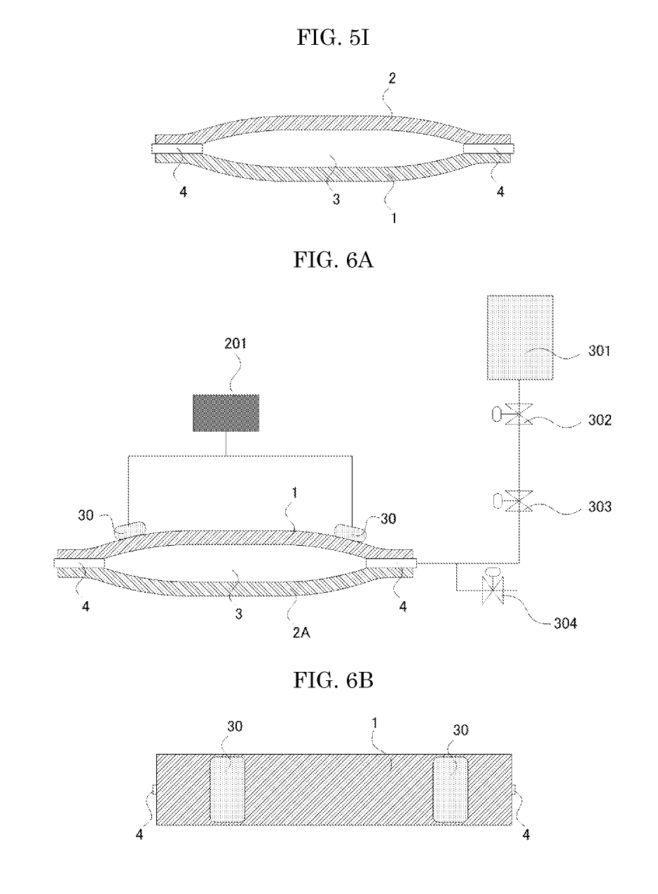

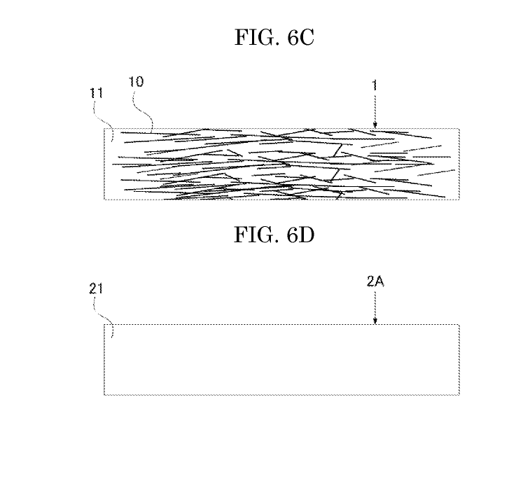

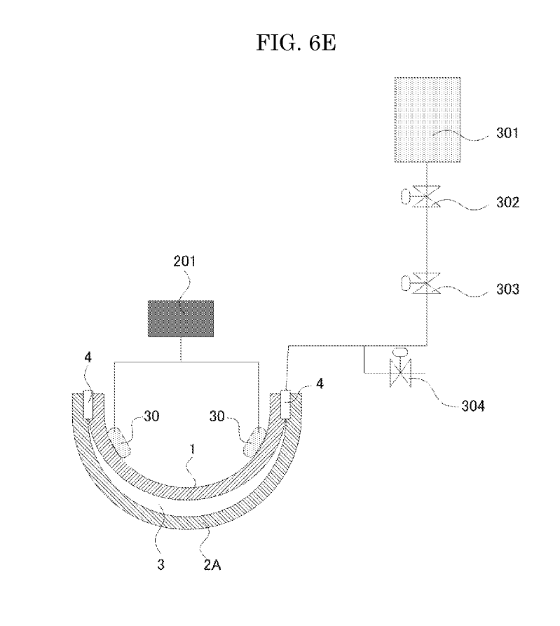

FIGS. 6A to 6E are schematic diagrams illustrating one example of the driving device of the present invention.

FIG. 6A is a cross-sectional view illustrating one example of the driving device of the present invention.

FIG. 6B is a top view illustrating one example of the hydraulic actuator in the driving device of FIG. 6A.

FIG. 6C is a top view illustrating one example of the orientation of the short fibers of the first elastic sheet 1.

FIG. 6D is a top view illustrating the second elastic sheet 2A.

FIG. 6E is a cross-sectional view illustrating a state when the hydraulic actuator is bent.

The driving device of FIGS. 6A to 6E contains the hydraulic actuator, an electric resistance value measuring unit 201, and a controlling unit.

The hydraulic actuator contains a first elastic sheet 1, a second elastic sheet 2A, a fluid storing chamber 3, and inlet-outlet pores each formed with a pipe 4. The first elastic sheet 1 and the second elastic sheet 2A are bonded together with the peripheral part of the first elastic sheet 1 overlapping with the peripheral part of the second elastic sheet 2A. The first elastic sheet 1 and the second elastic sheet 2A are not bonded other than the peripheral part of the first elastic sheet 1 and the peripheral part of the second elastic sheet 2A, and thus a fluid storing chamber 3 capable of storing a fluid is formed between the first elastic sheet 1 and the second elastic sheet 2A. Moreover, the inlet-outlet pores each capable of introducing and discharging a fluid into and from the fluid storing chamber 3 are formed with the pipes 4 at both ends of the first elastic sheet 1 and the second elastic sheet 2A relative to the longitudinal direction thereof. The pipe 4 of the left side is sealed with a stopper.

As illustrated in FIG. 6B, two electrodes 30 are attached to the outer surface of the first elastic sheet 1. The electric resistance value measuring unit 201 is configured to measure an electric resistance value of the first elastic sheet through the electrodes 30.

The controlling unit contains an air tank 301, a pressure controlling valve 302, and electromagnetic valves 303, 304.

As illustrated in FIG. 6C, the first elastic sheet 1 contains short fibers 10, and silicone rubber 11. In the first elastic sheet 1, the short fibers 10 are aligned in the longitudinal direction of the first elastic sheet 1.

As illustrated in FIG. 6D, the second elastic sheet 2A contains silicone rubber 21, but does not contain short fibers.

With the hydraulic actuator of FIGS. 6A to 6E, as a fluid is stored in the fluid storing chamber 3, the first elastic sheet 1 and the second elastic sheet 2A try to expand with the pressure caused by the fluid. As the first elastic sheet 1 contains the short fibers aligned in the longitudinal direction, the extension along the longitudinal direction is restricted, but the extension in the short direction is hardly restricted. On the other hand, the second elastic sheet 2A does not contain the short fibers, and thus there is no restriction applied on the extension as in the first elastic sheet 1. As a result, the hydraulic actuator bends in the direction of the first elastic sheet 1, as illustrated in FIG. 6E.

When the hydraulic actuator bends, an electric resistance value of the first elastic sheet 1 changes depending on a degree of the bend. Therefore, the degree of the bent of the first elastic sheet 1 can be understood by determining in advance a relationship between the electric resistance value of the first elastic sheet 1 and the degree of the bend. Therefore, the electric resistance value of the first elastic sheet 1 is measured by the electric resistance value measuring unit 201, and an amount of a fluid (air) fed into the fluid storing chamber 3 is controlled by adjusting the pressure control valve 302, which is the controlling unit, based on the measured electric resistance value. As a result, the degree of the bent of the hydraulic actuator is precisely controlled with a relatively simple structure.

Note that, the electric resistance value measuring unit 201 and the pressure controlling valve 302 may be connected with a wire (wired connection) or without a wire (wireless connection).

Subsequently, one example of the joint structure of the present invention is explained with reference to drawings.

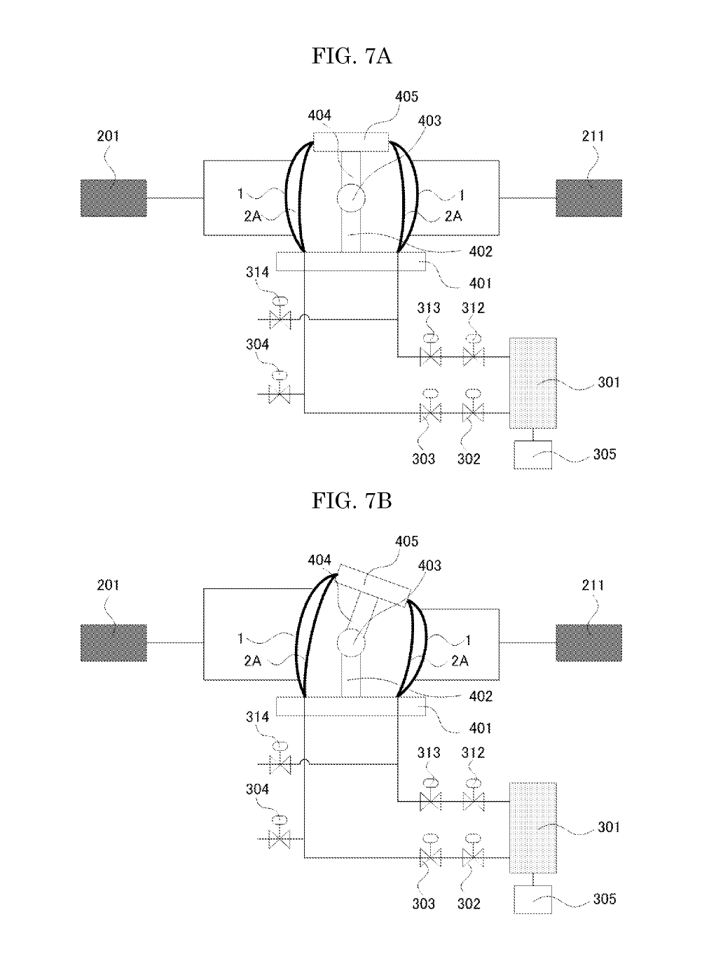

FIGS. 7A and 7B are schematic diagrams illustrating one example of the joint structure of the present invention.

The joint structure contains one joint, two hydraulic actuators, a controlling unit, and two electric resistance value measuring units 201, 211.

The joint contains a first support 401, a first shaft 402, a movable part 403, a second shaft 404, and a second support 405. The first shaft 402 is supported by the first support 401. The second shaft 404 is supported by the second support 405. The first shaft 402 and the second shaft 404 are connected together via the movable part 403. In the joint, an angle between the first shaft 402 and the second shaft 404 can be changed by the movable part 403.

For example, each hydraulic actuator has the structure illustrated in FIG. 6A, and contains a first elastic sheet 1, and a second elastic sheet is 2A. The first elastic sheet 1 contains short fibers, and silicone rubber. In the first elastic sheet 1, the short fibers are aligned in the longitudinal direction of the first elastic sheet 1. The second elastic sheet 2A contains silicone rubber, but does not contain short fibers. Note that, the second elastic sheet 2A may contain short fibers.

The two hydraulic actuators are provided with facing each other in a manner that the movable part 403 is sandwiched with the two hydraulic actuators. The two hydraulic actuators are arranged in a manner that the second elastic sheet 2A faces the side of the movable part 403.

One end of each hydraulic actuator is bonded to the first support 401, and the other end thereof is bonded to the second support 405.

The controlling unit contains one air tank 301. In order to control an amount of a fluid introduced into each hydraulic actuator, the controlling unit contains pressure controlling valves 302, 312, and electromagnetic valves 303, 304, 313, 314. Moreover, the controlling unit also contains a compressor 305 configured to send out the air in the air tank 301 to each hydraulic actuator.

The electric resistance value measuring units 201, 211 are respectively connected to the first elastic sheets 1 in a manner that an electric resistance value of the first elastic sheet 1 of each hydraulic actuator can be measured.

The pressure controlling valves 202, 212 are operated based on the electric resistance value of the first elastic sheet 1 of each hydraulic actuator measured by each of the electric resistance value measuring units 201, 211. As a result, each hydraulic actuator can be bent. Then, the joint is bent depending on the bent of each hydraulic actuator.

The joint structure of the present invention may be a multiple joint structure, where a plurality of the combination of the hydraulic actuators and the joint, as illustrated in FIG. 7A, is connected in series.

### EXAMPLES

Hereinafter, examples of the present invention are explained, but the following examples shall not be construed as to limit the scope of the present invention in any way. In the following examples, “parts” denotes “parts by weight” unless otherwise stated. Specifically, in the following examples, a blended amount and content of additives, such as fillers, are represented by parts by weight relative to 100 parts by weight of the rubber. This is corresponded to p.h.r. (per hundred rubber), which represents a weight of each additive when a weight of rubber before vulcanization is determined as 100.

### Production Example 1

### Surface Oxidization Treatment of Carbon Fibers

Carbon fibers (the average fiber length: 50 μm, the average diameter: 10 μm) are treated in the atmosphere at 500° C. for 30 minutes, to thereby obtain surface oxidization treated carbon fibers.

### Production Example 2

### Production of Natural Rubber Latex Liquid

To 100 parts (solid basis) of natural rubber latex (Selatex 1101, manufactured by SUMITOMO RUBBER INDUSTRIES, LTD.) having a solid content of 60% by weight, 0.3 parts of zinc dimethyldithiocarbamate, 1.5 parts of sulfur colloid (Golden Flower Colloidal Sulfur A, manufactured by Tsurumi Chemical Co., Ltd.), 3.0 parts of active zinc (META-Z, manufactured by Inoue Calcium Corporation), 1.2 parts of stearic acid, 10 parts of sodium dimethyl-5-sulfoisophthalate, 30 parts of carbon black (Asahi #78, manufactured by Asahi Carbon Co., Ltd.), and 20 parts of silica (Nipsil VN-3, manufactured by TOSOH SILICA CORPORATION) were added, to thereby obtain a natural rubber latex liquid.

### Example 1

### Production of Hydraulic Actuator

### <<Step 1-1>>

After mixing 100 parts (solid basis) of silicone rubber (DY35-2083, manufactured by Dow Corning Toray Co., Ltd.), and 20 parts of the surface oxidization treated carbon fibers obtained in Production Example 1, the resulting mixture was dispersed for 30 minutes by means of an orbiting-screw mixer (HIVIS MIX, manufactured by PRIMIX Corporation) where two blades are simultaneously driven with the revolution and rotation motions, to thereby obtain a silicone rubber composition 1.

### <<Step 1-2>>

Subsequently, the silicone rubber composition 1 was applied onto a stainless steel plate having a thickness of 5 mm by means of an automatic film applicator (KT-AB3125, manufactured by COTEC Corporation, gap: 230 μm), then the applied silicone rubber composition 1 was thermal cured at 80° C. for 10 minutes to thereby form a first elastic sheet precursor [1] having the average thickness of 200 μm, length of 100 mm and width of 50 mm. The application of the silicone rubber composition 1 was performed in a manner that the carbon fibers were aligned in the longitudinal direction of the first elastic sheet precursor [1]. Note that, in this state, the silicone rubber was not completely cured yet, and the first elastic sheet precursor [1] had tackiness.

### <<Step 1-3>>

Subsequently, a polytetrafluoroethylene sheet serving as a mask sheet was placed on a surface of the first elastic sheet precursor [1], which was to be a surface to be in contact with a second elastic sheet, as illustrated in FIG. 5D.

Subsequently, microballoons (Microballoon F-80DE, manufactured by Matsumoto Yushi-Seiyaku Co., Ltd.) were blown on an area of the surface of the first elastic sheet precursor [1], which was not covered with the mask sheet (FIG. 5E). The microballoons were balloons each formed of a film of nanometer-order, and were shrunk at about 200° C. that was secondary baking temperature. The microballoons were used as a separating agent between the first elastic sheet and the second elastic sheet.

### <<Step 1-4>>

Subsequently, the first elastic sheet precursor [1] was heated at 120° C. for 30 minutes, to fix the microballoons on the surface of the first elastic sheet precursor [1]. Thereafter, the mask sheet was released from the first elastic sheet precursor [1].

### <<Step 1-5>>

Subsequently, the silicone rubber composition 1 was applied on the surface of the first elastic sheet precursor [1], where the microballoons had been fixed, along the longitudinal direction of the first elastic sheet precursor [1] by means of an automatic film applicator (KT-AB3125, manufactured by COTEC Corporation, gap: 230 μm). The resultant was heated at 120° C. for 30 minutes to laminate a second elastic sheet precursor [1] on the first elastic sheet precursor [1], to thereby obtain a laminate.

### <<Step 1-6>>

Subsequently, the first elastic sheet precursor [1] was released from the stainless steel plate.

Subsequently, stainless-steel pipes (length: 30 mm, internal diameter: 5 mm), to which adhesive silicone rubber (DY35-2083, manufactured by Dow Corning Toray Co., Ltd.) had been deposited, were each inserted into the interface between the first elastic sheet precursor [1] and the second elastic sheet precursor [2] at the position that was a center of each edge of the laminate relative to the longitudinal direction of the first elastic sheet precursor [1] and the second elastic sheet precursor [1] in a manner that each pipe reached the surface where the microballoons had been fixed.

Subsequently, the laminate to which the stainless-steel pipes had been inserted was placed on a fluororesin sheet, and was heated at 200° C. for 4 hours. This heading cured the silicone rubber of the first elastic sheet precursor [1] and the second elastic sheet precursor [1], and popped the microballoons. As a result, the first elastic sheet and the second elastic sheet were obtained, at the same time as forming a fluid storing chamber, which was a space capable of storing a fluid, between the first elastic sheet and the second elastic sheet.

In the manner as described above, a hydraulic actuator was obtained.

### Comparative Example 1

A hydraulic actuator was produced in the same manner as in Example 1, provided that carbon roving (tensile strength: 3,950 MPa, tensile modulus: 238 GPa, Epoxy sizing: 0.067 g/m, Filament diameter: 7 μm, 1K) was bonded to each of the first elastic sheet and the second elastic sheet.

Specifically, the hydraulic actuator of Comparative Example 1 was produced in the following manner.

Step 1-1 and Step 1-2 of Example 1 were replaced with the following step 1A-2.

### <<Step 1A-2>>

Silicone rubber (DY35-2083, manufactured by Dow Corning Toray Co., Ltd) was applied on a stainless steel plate having a thickness of 5 mm by means of an automatic film applicator (KT-AB3125, manufactured by COTEC Corporation, gap: 230 μm). The carbon roving was pressed thereon in a manner that the axial direction of the carbon roving was to run along with the longitudinal direction of a first elastic sheet precursor [1A] to be obtained by applying the silicone rubber. Thereafter, the resultant was thermal cured at 80° C. for 10 minutes, to thereby form a first elastic sheet precursor [1A] having the average thickness of 200 length of 100 mm, and width of 50 mm. Note that, in this state, the silicone rubber was not completely cured yet, and the first elastic sheet precursor [1A] had tackiness. Moreover, the amount of the carbon roving was equal to the amount of the surface oxidization treated carbon fiber in the first elastic sheet precursor [1] of Example 1.

Subsequently, Step 1-3, and Step 1-4 of Example 1 were carried out.

Subsequently, the following step 1A-5 was carried out instead of Step 1-5 of Example 1.

### <<Step 1A-5>>

Silicone rubber (DY35-2083, manufactured by Dow Corning Toray Co., Ltd.) was applied on the surface of the first elastic sheet precursor [1A] where the microballoons had been fixed, along the longitudinal direction of the first elastic sheet precursor [1A] by means of an automatic film applicator (KT-AB3125, manufactured by COTEC Corporation, gap: 230 μm). The carbon roving was pressed thereon in a manner that the axial direction of the carbon roving was to run along the longitudinal direction of a second elastic sheet precursor [1A] obtained by applying the silicone rubber. Thereafter, the resultant was heated at 120° C. for 30 minutes to laminate a second elastic sheet precursor [1A] on the first elastic sheet precursor [1A], to thereby obtain a laminate. Moreover, the amount of the carbon roving was equal to the amount of the surface oxidization treated carbon fibers in the second elastic sheet precursor [1] of Example 1.

Subsequently, Step 1-6 of Example 1 was carried out.

In the manner described above, the hydraulic actuator of Comparative Example 1 was obtained.

### Example 2

A hydraulic actuator, to which an inflation controlling unit configured to control an expansion amount in a thickness direction was provided, was produced.

Specifically, the hydraulic actuator of Example 2 was produced in the following manner.

A step was carried out in the same manner as Step 1-3 of Example 1, provided that a polytetrafluoroethylene sheet serving as a mask sheet was placed on a surface of the first elastic sheet precursor [1], which was to be a surface to be in contact with a second elastic sheet, as illustrated in FIG. 5D, and a polytetrafluoroethylene sheet serving as a mask sheet for producing an inflation controlling unit was placed at a center part relative to a planar direction of the first elastic sheet precursor [1].

Moreover, a step was carried out in the same manner as in Step 1-4 of Example 1, provided that the mask sheet for producing an inflation controlling unit was released in addition to the mask sheet.

Other than the steps mentioned above, the hydraulic actuator of Example 2 was produced in the same manner as in Example 1.

### Example 3

A hydraulic actuator, which was bendable, was produced.

Specifically, the hydraulic actuator of Example 3 was produced in the following manner.

Step 1-5 of Example 1 was replaced with the following step 3-5.

### <<Step 3-5>>

Silicone rubber (DY35-2083, manufactured by Dow Corning Toray Co., Ltd.) was applied on the surface of the first elastic sheet precursor [1], where the microballoons had been fixed, along the longitudinal direction of the first elastic sheet precursor [1] by means of an automatic film applicator (KT-AB3125, manufactured by COTEC Corporation, gap: 230 μm). Thereafter, the resultant was heated at 120° C. for 30 minutes to laminate a second elastic sheet precursor [3] on the first elastic sheet precursor [1], to thereby obtain a laminate.

Other than the step mentioned above, the hydraulic actuator of Example 3 was produced in the same manner as in Example 1.

### Comparative Example 2

A hydraulic actuator, which used carbon roving, and was bendable, was produced.

Specifically, the hydraulic actuator of Comparative Example 2 was produced in the following manner.

Step 1A-5 of Comparative Example 1 was replaced with the following step 2A-5.

### <<Step 2A-5>>

Silicone rubber (DY35-2083, manufactured by Dow Corning Toray Co., Ltd.) was applied on the surface of the first elastic sheet precursor [1A], where the microballoons had been fixed, along the longitudinal direction of the first elastic sheet precursor [1A] by means of an automatic film applicator (KT-AB3125, manufactured by COTEC Corporation, gap: 230 μm). Thereafter, the resultant was heated at 120° C. for 30 minutes to laminate a second elastic sheet precursor [2A] on the first elastic sheet precursor [1A], to thereby obtain a laminate.

Other than the step mentioned above, the hydraulic actuator of Comparative Example 2 was produced in the same manner as in Comparative Example 1.

### Example 4

A hydraulic actuator was produced using natural rubber.

Specifically, the hydraulic actuator of Example 4 was produced in the following manner.

### <<Step 4-1>>

After mixing 100 parts of the natural rubber latex liquid obtained in Production Example 2 and 20 parts of the surface oxidization treated carbon fibers obtained in Production Example 1, the resulting mixture was dispersed by means of an orbiting-screw mixer (HIVIS MIX, manufactured by PRIMIX Corporation) where two blades are simultaneously driven with the revolution and rotation motions, to thereby obtain a natural rubber latex composition 1.

### <<Step 4-2>>

Subsequently, the natural rubber latex composition 1 was applied on a 5 mm-thick stainless steel plate, to which a release agent had been applied, by means of an automatic film applicator (KT-AB3125, manufactured by COTEC Corporation, gap: 230 μm). Then, the applied natural rubber latex composition 1 was thermal cured (vulcanized) at 80° C. for 10 minutes, to thereby form a first elastic sheet precursor [4] having the average thickness of 200 μm, length of 100 mm, and width of 50 mm. The application of the natural rubber latex composition 1 was performed in a manner that the carbon fibers were aligned in the longitudinal direction of the first elastic sheet precursor [4]. Note that, in this state, the natural rubber was not completely cured yet, and the first elastic sheet precursor [4] had tackiness.

### <<Step 4-3>>

Subsequently, a polytetrafluoroethylene sheet serving as a mask sheet was placed on a surface of the first elastic sheet precursor [4], which was to be a surface to be in contact with a second elastic sheet, as illustrated in FIG. 5D.

Subsequently, microballoons (Microballoon F-80DE, manufactured by Matsumoto Yushi-Seiyaku Co., Ltd.) were blown on an area of the surface of the first elastic sheet precursor [4], which was not covered with the mask sheet (FIG. 5E). The microballoons were used as a separating agent between the first elastic sheet and the second elastic sheet.

### <<Step 4-4>>

Subsequently, the first elastic sheet precursor [4] was heated (vulcanized) at 80° C. for 10 minutes, to fix the microballoons on the surface of the first elastic sheet precursor [4]. Thereafter, the mask sheet was released from the first elastic sheet precursor [4].

### <<Step 4-5>>

Subsequently, the natural rubber latex composition 1 was applied on the surface of the first elastic sheet precursor [4], where the microballoons had been fixed, along the longitudinal direction of the first elastic sheet precursor [4] by means of an automatic film applicator (KT-AB3125, manufactured by COTEC Corporation, gap: 230 μm). Thereafter, the resultant was heated (vulcanized) at 80° C. for 10 minutes to laminate a second elastic sheet precursor [4] on the first elastic sheet precursor [4], to thereby obtain a laminate.

### <<Step 4-6>>

Subsequently, the first elastic sheet precursor [4] was released from the stainless steel plate.

Subsequently, stainless-steel pipes (length: 30 mm, internal diameter: 5 mm), to which a natural rubber-based adhesive (TB1521B, manufactured by ThreeBond holdings Co., Ltd.) had been deposited, were each inserted into the interface between the first elastic sheet precursor [4] and the second elastic sheet precursor [4] at the position that was a center of each edge of the laminate relative to the longitudinal direction of the first elastic sheet precursor [4] and the second elastic sheet precursor [4] in a manner that each pipe reached the surface where the microballoons had been fixed.

Subsequently, the laminate to which the stainless-steel pipes had been inserted was placed on a fluororesin sheet, and was heated (vulcanized) at 70° C. for 12 hours. This heating vulcanized the natural rubber of the first elastic sheet precursor [4] and the second elastic sheet precursor [4] to form a first elastic sheet and a second elastic sheet. The balloons were not shrunk at the aforementioned temperature. Therefore, air was blown in from the pipes to discharge the microballoons from the interface between the first elastic sheet precursor [4] and the second elastic sheet precursor [4], to thereby form a fluid storing chamber, which was a space capable of storing a fluid, between the first elastic sheet and the second elastic sheet.

In the manner as described above, the hydraulic actuator of Example 4 was obtained.

### Example 5

A hydraulic actuator was obtained in the same manner as in Example 1, provided that the application method of the silicone rubber composition 1 was changed to a method containing dripping the silicone rubber composition 1 on a center of a coating surface to a surrounding of which a gap having a thickness of 200 μm was provided, waiting for the silicone rubber composition 1 to level, and laminating a polytetrafluoroethylene plate having a thickness of 5 mm to give a thickness of 200 μm to the silicone rubber composition 1.

### Example 6

A hydraulic actuator was obtained in the same manner as in Example 1, provided that the dispersion time in Step 1-1 was changed to 20 minutes, and the application method of the silicone rubber composition 1 was changed to a method containing dripping the silicone rubber composition 1 on a center of a coating surface to a surrounding of which a gap having a thickness of 200 μm was provided, waiting for the silicone rubber composition 1 to level, and laminating a polytetrafluoroethylene plate having a thickness of 5 mm to give a thickness of 200 μm to the silicone rubber composition 1.

### Example 7

A hydraulic actuator was obtained in the same manner as in Example 1, provided that the dispersion time in Step 1-1 was changed to 10 minutes, and the application method of the silicone rubber composition 1 was changed to a method containing dripping the silicone rubber composition 1 on a center of a coating surface to a surrounding of which a gap having a thickness of 200 μm was provided, waiting for the silicone rubber composition 1 to level, and laminating a polytetrafluoroethylene plate having a thickness of 5 mm to give a thickness of 200 μm to the silicone rubber composition 1.

### Examples 8 to 12

Hydraulic actuators were each produced in the same manner as in Example 1, provided that the surface oxidization treated carbon fibers were replaced with the glass fibers as depicted in the following table 1.

TABLE 1

| | | Average | Fiber |
|---|---|---|---|
| | | fiber length | diameter |
| | Product Name | (μm) | (μm) |
| Ex. 8 | Milled Fiber | 50 | 11 |
| | EFH50-31 | | |
| Ex. 9 | Milled Fiber | 75 | 11 |
| | EFH75-01 | | |
| Ex. 10 | Milled Fiber | 100 | 11 |
| | EFH100-31 | | |
| Ex. 11 | Milled Fiber | 150 | 11 |
| | EFH150-01 | | |
| Ex. 12 | Milled Fiber | 30 | 11 |
| | EFH30-31 | | |

The glass fibers in Table 1 were all manufactured by Central Glass Co., Ltd.

### <Degree of Orientation>

The degree of orientation was measured in the following manner.

A surface of the first elastic sheet or second elastic sheet was observed under a microscope (for example, KEYENCE Microscope: VHX-1000, zoom lens: VH-Z100R, manufactured by KEYENCE CORPORATION) at 300× magnification (field of view: 800 μm×600 μm), to determine a ratio (%) of the short fibers aligning with an angle within ±30° from the longitudinal direction. Note that, in the observation, only the short fibers having the length of 30 μm or longer were treated as the observation targets, and the fibers having the length shorter than 30 μm were excluded from the observation targets.

The average value obtained when arbitrarily selected 12 positions on the surface of the first elastic sheet or second elastic sheet were measured, was determined as the degree of orientation. The results are depicted in Tables 2 and 3.

### <Expansion Rate and Contraction Rate>

An expansion rate and a contraction rate when a fluid at the predetermined pressure was introduced into the fluid storing chamber were measured. The expansion rate and the contraction rate are defined with the following formulae. The results are presented in Tables 2 and 3.

Contraction rate (%)=100×(L₀-Lₚ)/L₀
Expansion rate (%)=100×(tₚ-t₀)/t₀

In the formulae above, L₀ is a length of the actuator when no pressure is applied; Lₚ is a length of the actuator when the pressure is applied; t₀ is the maximum thickness of the actuator when no pressure is applied; and tₚ is the maximum thickness of the actuator when the pressure is applied.

### <Evaluation of Durability>

The longitudinal direction of the stretchable hydraulic actuator was aligned in the gravity direction, the inlet-outlet pore of the top side was fixed, and hook was hooked on the inlet-outlet pore of the bottom side. The weight of 200 g was hooked on the hook. The pressure of the fluid (air) introduced into the fluid storing chamber was set to 0.05 MPa, and the hydraulic actuator was moved up and down (expansion and contraction) at 30 time/min by opening and closing the compressed air valve. The motions of up and down were carried out 50,000 maximum. When the actuator was damaged, the number of the times of the expansion and contraction at which the actuator was damaged was presented in Tables 2 and 3. In the case where the actuator was not damaged even with 50,000 times, it was depicted as “>50,000” in Tables 2 and 3.

Note that, in case of the bendable hydraulic actuator (Example 3 and Comparative Example 2), the measurement was performed under the same conditions to the above, provided that a string was tied to the inlet-outlet pore of the bottom side, a fixed pulley (not illustrated) was provided at the end of the string, a hook was provided to the string extended from the pulley, and the weight of 200 g was similarly provided on the hook.

TABLE 2

| | Ex. 1 | Ex. 2 | Ex. 3 | Ex. 4 | Ex. 5 | Ex. 6 | Ex. 7 |
|---|---|---|---|---|---|---|---|
| Type | Stretchable | Stretchable | Bendable | Stretchable | Stretchable | Stretchable | Stretchable |
| Silicone rubber | 100 | 100 | 100 | — | 100 | 100 | 100 |
| (weight parts) | | | | | | | |
| Natural rubber | — | — | — | 100 | — | — | — |
| (weight parts) | | | | | | | |
| Short fibers | 40 | 40 | 40 | 40 | 40 | 40 | 40 |
| (weight parts) | | | | | | | |
| Orientation | 85 | 82 | 82 | 92 | 52 | 65 | 67 |
| degree | | | | | | | |
| (%) | | | | | | | |
| Contraction rate | 18 | 16 | — | — | 2 | 5 | 8 |
| (%) at pressure of | | | | | | | |
| 0.02 MPa | | | | | | | |
| Contraction rate | 31 | 25 | 25 | 38 | 8 | 12 | 14 |
| (%) at pressure of | | | | | | | |
| 0.05 MPa | | | | | | | |
| Contraction rate | 42 | 35 | — | — | 11 | 18 | 20 |
| (%) at pressure of | | | | | | | |
| 0.08 MPa | | | | | | | |
| Expansion rate | 16 | 12 | — | — | 22 | 18 | 16 |
| (%) at pressure of | | | | | | | |
| 0.02 MPa | | | | | | | |
| Expansion rate | 38 | 18 | 40 | 20 | 35 | 30 | 35 |
| (%) at pressure of | | | | | | | |
| 0.05 MPa | | | | | | | |
| Expansion rate | 52 | 22 | — | — | 45 | 40 | 40 |
| (%) at pressure of | | | | | | | |
| 0.08 MPa | | | | | | | |
| Durability | >50,000 | >50,000 | >50,000 | >50,000 | >50,000 | >50,000 | >50,000 |

TABLE 3

| | | | | | | Comp. | Comp. |
|---|---|---|---|---|---|---|---|
| | Ex. 8 | Ex. 9 | Ex. 10 | Ex. 11 | Ex. 12 | Ex. 1 | Ex. 2 |
| Type | Stretchable | Stretchable | Stretchable | Stretchable | Stretchable | Stretchable | Bendable |
| Silicone | 100 | 100 | 100 | 100 | 100 | 100 | 100 |
| rubber | | | | | | | |
| (weight | | | | | | | |
| parts) | | | | | | | |
| Short fibers | 40 | 40 | 40 | 40 | 40 | — | — |
| (weight | | | | | | | |
| parts) | | | | | | | |
| Orientation | 85 | 88 | 91 | 96 | 52 | — | — |
| degree | | | | | | | |
| (%) | | | | | | | |
| Contraction | 35 | 37 | 38 | 40 | −5 | 15 | 10 |
| rate (%) at | | | | | | | |
| pressure of | | | | | | | |
| 0.05 MPa | | | | | | | |
| Expansion | 40 | 38 | 37 | 37 | 40 | 40 | 43 |
| rate (%) at | | | | | | | |
| pressure of | | | | | | | |
| 0.05 MPa | | | | | | | |
| Durability | >50,000 | >50,000 | >50,000 | >50,000 | >50,000 | 13,200 | 8,720 |

### Example 13

A hydraulic actuator, which was bendable, was produced.

Specifically, the hydraulic actuator of Example 13 was produced in the following manner.

Step 1-5 of Example 1 was replaced with the following step 3-5.

### <<Step 3-5>>

Silicone rubber (DY35-2083, manufactured by Dow Corning Toray Co., Ltd.) was applied on the surface of the first elastic sheet precursor [1], where the microballoons had been fixed, along the longitudinal direction of the first elastic sheet precursor [1] by means of an automatic film applicator (KT-AB3125, manufactured by COTEC Corporation, gap: 230 μm). Thereafter, the resultant was heated at 120° C. for 30 minutes to laminate a second sheet precursor [3] on the first elastic sheet precursor [1], to thereby obtain a laminate.

Moreover, a step was carried out in the same manner as in Step 1-6 of Example 1, provided the laminate was fixed to a stainless steel tube having a diameter of 30 mm during the heating, to thereby bend to the second elastic sheet side at an initial state.

Other than the steps mentioned above, two hydraulic actuators were produced in the same manner as in Example 1.

Electrodes were provided at the positions of the first elastic sheet of each of the two hydraulic actuators, as illustrated in FIG. 6B.

A driving device illustrated in FIG. 7A was produced using the two hydraulic actuators.

A relationship between the extension of one of the two hydraulic actuator and the resistance value was studied. Note that, the measurement was performed in the state where the electromagnetic valve connected to the other hydraulic actuator was open.

The extension (%) was determined by measuring a length between two fixed points, and determining the result as an extension rate relative to the initial length.

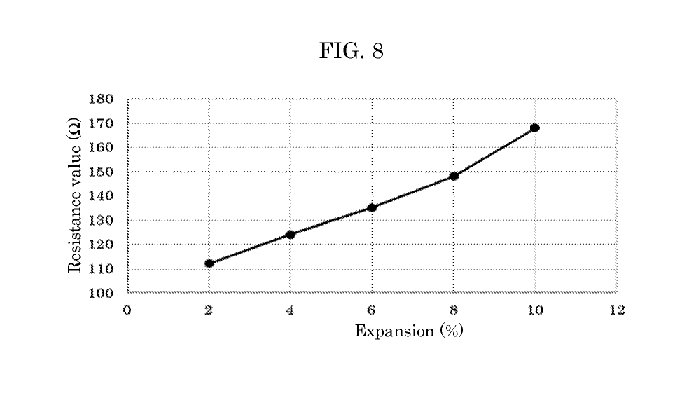

The result is presented in FIG. 8. It could be understood from FIG. 8 that the extension could be determined by measuring the resistance value of the first elastic sheet.

### Example 14

In the course of the production of a hydraulic actuator in Example 1, the laminate was fixed to a stainless steel tube having a diameter of 30 mm during the heating, to thereby bend to the second elastic sheet side at an initial state, similarly to Example 13. Other than the above, a hydraulic actuator was produced in the same manner as in Example 1. A driving device illustrated in FIG. 7A was produced using two hydraulic actuator as produced in the same manner as in Example 13. Then, the following evaluations were performed.

### <Measurement of Left-Right Vibration Time>

The time during which the second axis of the driving device was return from left to right once was measured relative to the pressure of the compressed air. As for the measurement, the pressure of the compressed air was adjusted to the set value (see Table 4) by the pressure controlling valve in advance, followed by driving the device. Moreover, the driving device was adjusted to move left and right with 30°, and then the device was driven. The motions of the driving device was filmed by a digital camera RICOH CX6 (manufactured by Ricoh Company Limited), and the positions of left and right were confirmed in the 30 frames, and the driving device was driven for the motions of 100 returns. The time required for 100 returns was measured, and the average return time per return was determined from the measured time. The result is presented in Table 4.

### <Evaluation of Durability>

In the same manner as in the measurement of the vibration time, the second axis of the driving device was driven left and right. Then, a durability test was performed.

The time for the 100 returns in the vibration time measurement was multiplied by 100 times, to determine the return time for 10,000 times. The motions of the driving device was filmed per the 10,000 return time by means of the digital camera, to confirm the operational state and damage.

As for the durability test, the pressure for introducing the fluid (air) into the fluid storing chamber was set to 0.05 MPa, and the driving device was driven for 50,000 returns maximum, to determine the number of the returns when the actuator was damaged. In the case where there was no defect in the operational state, and no damage even after the motions of the 50,000 returns, it was depicted as “>50,000” in Table 4.

### Examples 15 to 20

A driving device was produced in the same manner as in Example 14, provided that the hydraulic actuator for use was replaced with the hydraulic actuator as depicted in Table 4. The produced driving device was evaluated in the same manner as in Example 14. The results are presented in Table 4.

### Comparative Examples 3 and 4

A driving device was produced in the same manner as in Example 14, provided that the hydraulic actuator for use was replaced with the hydraulic actuator as depicted in Table 5. The produced driving device was evaluated in the same manner as in Example 14. The results are presented in Table 5.

TABLE 4

| | Ex. 14 | Ex. 15 | Ex. 16 | Ex. 17 | Ex. 18 | Ex. 19 | Ex. 20 |
|---|---|---|---|---|---|---|---|
| | Ex. 1 | Ex. 2 | Ex. 3 | Ex. 4 | Ex. 5 | Ex. 6 | Ex. 7 |
| Type | Stretchable | Stretchable | Bendable | Stretchable | Stretchable | Stretchable | Stretchable |
| Silicone | 100 | 100 | 100 | — | 100 | 100 | 100 |
| rubber | | | | | | | |
| (weight parts) | | | | | | | |
| Natural | — | — | — | 100 | — | — | — |
| rubber | | | | | | | |
| (weight parts) | | | | | | | |
| Pitch-type | 40 | 40 | 40 | 40 | 40 | 40 | 40 |
| XN-100 | | | | | | | |
| (weight parts) | | | | | | | |
| Orientation | 85 | 82 | 82 | 92 | 52 | 65 | 67 |
| degree | | | | | | | |
| (%) | | | | | | | |
| Average | 5.1 | 5.6 | 4.1 | 5.6 | 10.0 | 9.2 | 8.1 |
| return time at | | | | | | | |
| pressure of | | | | | | | |
| 0.02 MPa | | | | | | | |
| (sec) | | | | | | | |
| Average | 3.5 | 3.2 | 2.9 | 3.4 | 8.5 | 7.1 | 6.2 |
| return time at | | | | | | | |
| pressure of | | | | | | | |
| 0.05 MPa | | | | | | | |
| (sec) | | | | | | | |
| Average | 1.2 | 1.3 | 0.9 | 1.2 | 5.5 | 4.1 | 3.5 |
| return time at | | | | | | | |
| pressure of | | | | | | | |
| 0.08 MPa | | | | | | | |
| (sec) | | | | | | | |
| Durability | >50,000 | >50,000 | >50,000 | >50,000 | >50,000 | >50,000 | >50,000 |

TABLE 5

| | Comp. Ex. 3 | Comp. Ex. 4 |
|---|---|---|
| Type | Comp. Ex. 1 | Comp. Ex. 2 |
| | Stretchable | Bendable |
| Silicone rubber | 100 | 100 |
| (weight parts) | | |
| Carbon roving | 40 | 40 |
| (weight parts) | | |
| Orientation degree | | |
| (%) | | |
| Average return time at | 10.2 | 12.1 |
| pressure of 0.02 MPa | | |
| (sec) | | |
| Average return time at | 8.5 | 10.2 |
| pressure of 0.05 MPa | | |
| (sec) | | |
| Average return time at | 5.5 | 4.3 |
| pressure of 0.08 MPa | | |
| (sec) | | |
| Durability | <20,000 | <10,000 |

### Example 21

### Production of Hydraulic Actuator

### <<Step 21-1>>

After mixing 100 parts (solid basis) of silicone rubber (DY35-2083, manufactured by Dow Corning Toray Co., Ltd.), and 20 parts of surface oxidization treated carbon fibers (GRANOC®XN-100-05M, manufactured by Nippon Graphite Fiber Co., Ltd.), the resulting mixture was dispersed by means of an orbiting-screw mixer (HIVIS MIX, manufactured by PRIMIX Corporation) where two blades are simultaneously driven with the revolution and rotation motions, to thereby obtain a silicone rubber composition 21.

### <<Step 21-2>>

Subsequently, the silicone rubber composition 21 was applied on a nickel electrocast belt having a thickness of 40 μm, a diameter of 10 mm, and a length of 200 mm by ring coating (see JP-A No. 2004-290853), to give the average thickness of 200 μm. The resultant was thermal cured at 120° C. for 15 minutes, followed by further heating the silicone rubber composition 21 at 200° C. for 4 hours. The obtained tube-shaped silicone rubber (tubular elastic body) did not have adhesion, and thus it was easily released from the nickel electrocast belt by bending the nickel electrocast belt inwards. Both ends of the tubular elastic body were cut off to give the tubular elastic body having a total length of 100 mm. A couple of pipes were respectively inserted into the both edges of the tubular elastic body, and the openings of the both edges were sealed, to thereby obtain a hydraulic actuator.

### Comparative Example 5

### Production of Hydraulic Actuator

Silicone rubber (DY35-2083, manufactured by Dow Corning Toray Co., Ltd.) was applied on a nickel electrocast belt having a thickness of 40 μm, a diameter of 10 mm, and a length of 200 mm to give the average thickness of 200 μm. In addition, carbon roving (tensile strength: 3,950 MPa, tensile modulus: 238 GPa, Epoxy sizing: 0.067 g/m, Filament diameter: 7 μm, 1K) was pressed on the silicone rubber, and was fixed thereon. Thereafter, the resultant was thermal cured at 120° C. for 15 minutes, followed by further heating the silicone rubber at 200° C. for 4 hours. The obtained tube-shaped silicone rubber (tubular elastic body) did not have adhesion, and thus it was easily released from the nickel electrocast belt by bending the nickel electrocast belt inwards. Both ends of the tubular elastic body were cut off to give the tubular elastic body having a total length of 100 mm. A couple of pipes were respectively inserted into the both edges of the tubular elastic body, and the openings of the both edges were sealed, to thereby obtain a hydraulic actuator.

Note that, the amount of the carbon roving used was identical to the amount of the carbon fibers in Example 21.

The hydraulic actuators of Example 21 and Comparative Example 5 were compared in terms of durability thereof.

Each hydraulic actuator was lifted vertically, and the side of the compressed air introducing valve (the top side) was fixed, followed by providing a hook at the side of the discharging valve (the bottom side). The weight of 200 g was hooked on the hook, and the introducing air pressure was set to 0.05 MPa. Then, the hydraulic actuator was expanded and contracted in the up and down directions at 30 time/min using the compressed air.

The expansion and contraction for 1 time were performed in the following manner. The discharging valve was closed, and the compressed air was introduced, to lift the weight up. Subsequently, the introduction valve was closed, and the discharging valve was opened, to drop the weight.

The hydraulic actuator of Example 21 was not damaged with the expansion and contraction performed 50,000 times, but the hydraulic actuator of Comparative Example 5 was damaged at the expansion and contraction of 11,217 times.

The embodiments of the present invention are, for example, as follows.

<1> A hydraulic actuator, containing:

a tubular elastic body, at least part of which contains short fibers aligned in a longitudinal direction;

a fluid storing chamber, which is formed within an internal space of the tubular elastic body, and can store a fluid; and an inlet-outlet pore, which is formed at least one end of the tubular elastic body relative to the longitudinal direction, and can introduce and discharge the fluid into and from the fluid storing chamber.

<2> The hydraulic actuator according to <1>, wherein the tubular elastic body is composed of a first elastic sheet, and a second elastic sheet, where the second elastic sheet is overlapped with the first elastic sheet, and a peripheral part of the second elastic sheet is bonded to a peripheral part of the first elastic sheet,

wherein the fluid storing chamber is formed between the first elastic sheet and the second elastic sheet,

wherein the inlet-outlet pore is formed at least one end relative to a longitudinal direction of the first elastic sheet and the second elastic sheet, and

wherein the first elastic sheet, or the second elastic sheet, or both contain the short fibers aligned in the longitudinal direction.

<3> The hydraulic actuator according to <2>, wherein the first elastic sheet or the second elastic sheet contains the short fibers aligned in the longitudinal direction.
<4> The hydraulic actuator according to any one of <1> to <3>, wherein a degree of the orientation of the short fibers is 70% or greater.
<5> The hydraulic actuator according to any one of <1> to <4>, wherein the short fibers are carbon fibers, or glass fibers.
<6> The hydraulic actuator according to any one of <1> to <5>, wherein the tubular elastic body contains silicone rubber, or natural rubber.
<7> The hydraulic actuator according to <1>, wherein the tubular elastic body has electrical conductivity.
<8> The hydraulic actuator according to <2>, wherein the first elastic sheet, or the second elastic sheet, or both is an elastic sheet containing short fibers, and having electrical conductivity.
<9> A production method of a hydraulic actuator, containing:

applying a coating liquid containing short fibers and rubber on a coating surface using a coating unit, with relatively moving the coating surface and the coating unit,

wherein the hydraulic actuator is the hydraulic actuator according any one of <1> to <8>, and

wherein the coating unit is a coating unit, which is configured to apply the coating liquid on the coating surface with passing the coating liquid through a space between the coating surface and the coating unit.

<10> A driving method of a hydraulic actuator, containing:

measuring an electric resistance value of the tubular elastic body of the hydraulic actuator according to any one of <1> to <8>; and

controlling an amount of a fluid to be introduced into the hydraulic actuator based on the measured electric resistance value.

<11> A driving device, containing:

the hydraulic actuator according to any one of <1> to <8>;

an electric resistance value measuring unit, which is connected to the tubular elastic body of the hydraulic actuator, and is configured to measure an electric resistance value of the tubular elastic body; and

a controlling unit configured to control an amount of a fluid to be introduced into the hydraulic actuator based on the measured electric resistance value.

<12> A joint structure, containing:

the hydraulic actuator according to any one of <1> to <8>; and

a joint moved by the hydraulic actuator.

This application claims priority to Japanese application No. 2014-043398, filed on Mar. 6, 2014 and incorporated herein by reference, and Japanese application No. 2014-253796, filed on Dec. 16, 2014 and incorporated herein by reference.

What is claimed is:

1. A hydraulic actuator, comprising:
a tubular elastic body, at least part of which contains short fibers aligned in a longitudinal direction;
a fluid storing chamber, which is formed within an internal space of the tubular elastic body, and can store a fluid; and
an inlet-outlet pore, which is formed at least one end of the tubular elastic body relative to the longitudinal direction, and can introduce and discharge the fluid into and from the fluid storing chamber.

2. The hydraulic actuator according to claim 1, wherein the tubular elastic body is composed of a first elastic sheet, and a second elastic sheet, where the second elastic sheet is overlapped with the first elastic sheet, and a peripheral part of the second elastic sheet is bonded to a peripheral part of the first elastic sheet,
wherein the fluid storing chamber is formed between the first elastic sheet and the second elastic sheet,
wherein the inlet-outlet pore is formed at least one end relative to a longitudinal direction of the first elastic sheet and the second elastic sheet, and
wherein the first elastic sheet, or the second elastic sheet, or both contain the short fibers aligned in the longitudinal direction.

3. The hydraulic actuator according to claim 2, wherein the first elastic sheet or the second elastic sheet contains the short fibers aligned in the longitudinal direction.

4. The hydraulic actuator according to claim 1, wherein a degree of the orientation of the short fibers is 70% or greater.

5. The hydraulic actuator according to claim 1, wherein the short fibers are carbon fibers, or glass fibers.

6. The hydraulic actuator according to claim 1, wherein the tubular elastic body contains silicone rubber, or natural rubber.

7. The hydraulic actuator according to claim 1, wherein the tubular elastic body has electrical conductivity.

8. The hydraulic actuator according to claim 2, wherein the first elastic sheet, or the second elastic sheet, or both is an elastic sheet containing short fibers, and having electrical conductivity.

9. A driving device, comprising:
a hydraulic actuator;
an electric resistance value measuring unit, which is connected to a tubular elastic body of the hydraulic actuator, and is configured to measure an electric resistance value of the tubular elastic body; and
a controlling unit configured to control an amount of a fluid to be introduced into the hydraulic actuator based on the measured electric resistance value,
wherein the hydraulic actuator comprises:
the tubular elastic body, at least part of which contains short fibers aligned in a longitudinal direction;
a fluid storing chamber, which is formed within an internal space of the tubular elastic body, and can store the fluid; and
an inlet-outlet pore, which is formed at least one end of the tubular elastic body relative to the longitudinal direction, and can introduce and discharge the fluid into and from the fluid storing chamber.

10. A joint structure, comprising:
a hydraulic actuator; and
a joint moved by the hydraulic actuator,
wherein the hydraulic actuator comprises:
a tubular elastic body, at least part of which contains short fibers aligned in a longitudinal direction;
a fluid storing chamber, which is formed within an internal space of the tubular elastic body, and can store a fluid; and
an inlet-outlet pore, which is formed at least one end of the tubular elastic body relative to the longitudinal direction, and can introduce and discharge the fluid into and from the fluid storing chamber.
